(19) United States
(12) Patent Application Publication
(10) Pub. No.: US 2021/0122130 A1
(43) Pub. Date: Apr. 29, 2021

(54) PRESS DEVICE

(71) Applicant: KOMATSU INDUSTRIES CORPORATION, Kanazawa-shi, Ishikawa (JP)

(72) Inventors: Yusuke MASATO, Kanazawa-shi, Ishikawa (JP); Hikaru NISHIKAWA, Kanazawa-shi, Ishikawa (JP); Takashi MASANO, Minato-ku, Tokyo (JP)

(21) Appl. No.: 16/494,035

(22) PCT Filed: May 25, 2018
(86) PCT No.: PCT/JP2018/020217

§ 371 Date: Sep. 13, 2019

(30) Foreign Application Priority Data
Jul. 7, 2017 (JP) 2017-133758

(51) Int. Cl. B30B 15/34; B30B 15/14; B30B 1/26; H02M 7/48

(52) U.S. Cl. CPC B30B 15/34; H02M 7/48; B30B 1/266; B30B 15/148

(57) ABSTRACT

A press device is configured to subject a material to pressing by using an upper die and a lower die. The press device includes a slide, a bolster, a servomotor, an electric double layer capacitor, and a capacitor cooling unit. The upper die is attached to a lower face of the slide. The bolster is disposed under the slide. The lower die is disposed on the bolster. The servomotor drives the slide. The electric double layer capacitor is capable of supplying stored electric power to the servomotor. The capacitor cooling unit cools the electric double layer capacitors.

This application is a U.S. National Stage application of International Application No. PCT/JP2018/020217, filed May 25, 2018, which claims priority to Japanese Patent Application No. 2017-133758, filed Jul. 7, 2017, the contents of each of which are hereby incorporated herein by reference.

### BACKGROUND

### Field of Invention

The present invention relates to a press device.

### Background Information

For example, manufacturers of automobile and the like produce body panels with press devices featuring dies. Servomotor-driven press machines have been used in recent years as press devices.

With such servomotor-driven press machines, the peak power can be quite high during pressing, so the voltage inside or outside the factory may drop, leading to problems such as flickering.

In order to suppress the peak of electric power, a configuration has been disclosed in which an aluminum electrolytic capacitor is mounted in a press device (see JP A 2004 344946, for example).

### SUMMARY

However, with an aluminum electrolytic capacitor, the voltage drop cannot be suppressed if the peak power is large because the capacity is so small.

It is an object of this invention to provide a press device with which voltage drop can suppressed.

The press device according to the present invention is a press device to subject a material to pressing by using an upper die and a lower die, said press device comprising a slide, a bolster, a servomotor, an electric double layer capacitor, and a cooling unit. The upper die is attached to the lower face of the slide. The bolster is disposed below the slide, and the lower die is placed on the bolster. The servomotor drives the slide. The electric double layer capacitor is capable of supplying stored electric power to the servomotor. The cooling unit cools the electric double layer capacitor.

The present invention provides a press device with which voltage drop can be suppressed.

### BRIEF DESCRIPTION OF DRAWINGS

FIG. 1 is a simplified view of a press device in an embodiment according to the present invention;

FIG. 2 is an oblique view of a capacitor unit provided with a plurality of the electric double layer capacitors in FIG. 1;

FIG. 3 is an exploded oblique view of FIG. 2;

FIG. 4 shows the channel of a heat sink provided to the capacitor unit in FIG. 2;

FIG. 5 is an oblique view of a storage box that stores a plurality of the capacitor units in FIG. 2;

FIG. 6 is a front view illustrating the flow of air through the storage box in FIG. 5;

FIG. 7A is a flowchart of the operation of the press device in FIG. 1;

FIG. 7B is a flowchart of the operation of the press device in FIG. 1;

FIG. 8 is a graph of the power supplied from a factory power supply when the press device in FIG. 1 is used; and

FIG. 9 is a graph of the power supplied from a factory power supply in a comparative example in which an aluminum electrolytic capacitor is used instead of an electric double layer capacitor.

### DETAILED DESCRIPTION OF EMBODIMENT(S)

The press device of the present invention will be now described with reference to the drawings.

### 1. Configuration

### 1-1. Overview of Press Device

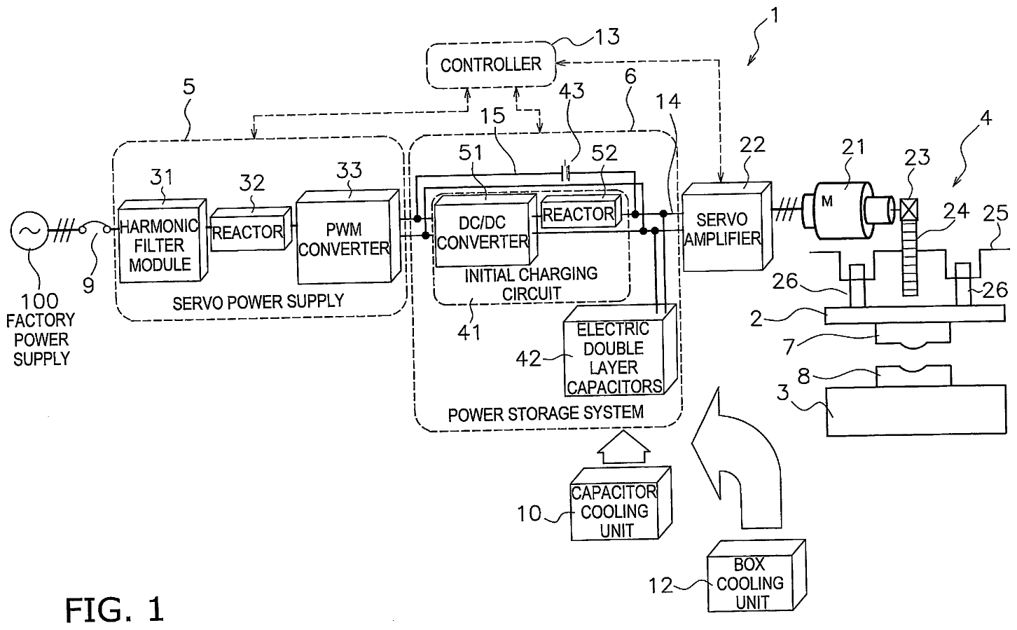

FIG. 1 is a simplified view of a press device 1 in an embodiment according to the present invention.

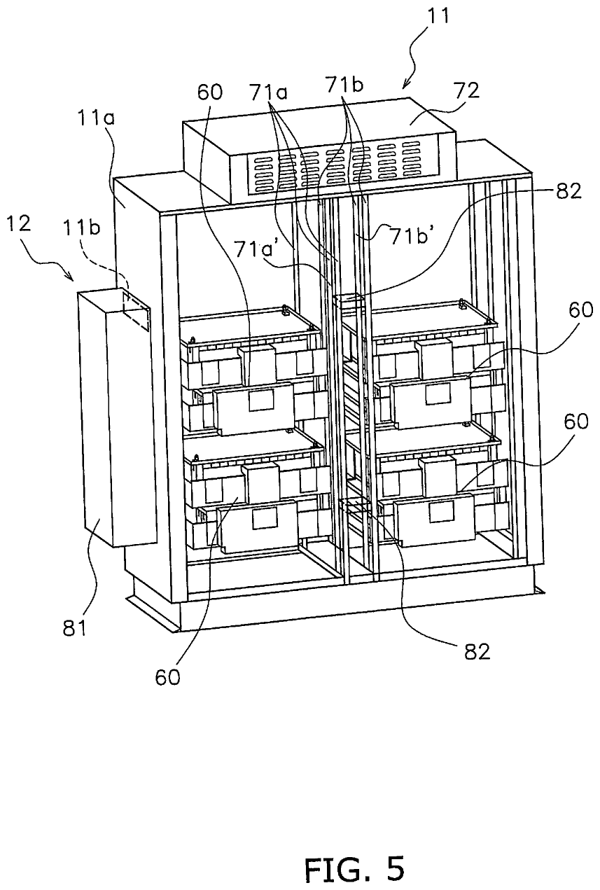

The press device 1 in this embodiment subjects a material to pressing using an upper die 7 and a lower die 8. The press device 1 mainly comprises a slide 2, a bolster 3, a slide driver 4, a servo power supply 5, a power storage system 6, a main breaker 9, a capacitor cooling unit 10, storage box 11 (see FIG. 5), a box cooling unit 12, and a controller 13.

The upper die 7 is attached to the lower face of the slide 2. The lower die 8 is placed on the upper face of the bolster 3. The slide driver 4 moves the slide 2 up and down. The servo power supply 5 converts the alternating current supplied from a factory power supply 100 into direct current and outputs it to the power storage system 6. The power storage system 6 stores the regenerative power produced by the slide driver 4 or the factory power supply 100. The main breaker 9 switches on and off the power supplied from the factory power supply 100 to the press device 1. The capacitor cooling unit 10 cools an electric double layer capacitor 42 (see FIG. 1) that stores electricity in the power storage system 6. The storage box 11 stores a plurality of the electric double layer capacitors 42. The box cooling unit 12 cools the inside of the storage box 11. The controller 13 controls the slide driver 4, the servo power supply 5, and the power storage system 6.

### 1-2. Slide Driver

The slide driver 4 includes a servomotor 21, a servo amplifier 22, a pinion gear 23, a main gear 24, a crankshaft 25, and connecting rods 26. The servomotor 21 is the drive source for the slide 2. The servo amplifier 22 supplies drive current to the servomotor 21. The pinion gear 23 is linked to the servomotor 21 and rotated by the rotation of the servomotor 21. The main gear 24 meshes with the pinion gear 23 and rotates along with the pinion gear 23. The crankshaft 25 is linked to the main gear 24 and rotated by the rotation of the main gear 24. The connecting rods 26 connect the crankshaft 25 and the slide 2. In this embodiment, two connecting rods 26 are provided.

When the servomotor 21 is rotated by drive current from the servo amplifier 22, the pinion gear 23 rotates, and the main gear 24 also rotates along with the pinion gear 23. The crankshaft 25 is rotated by the rotation of the main gear 24, and the connecting rod 26 moves up and down. This causes the slide 2 connected to the connecting rod 26 to move up and down.

### 1-3. Servo Power Supply

The servo power supply 5 has a harmonic filter module 31, a reactor 32, and a PWM converter 33. The harmonic filter module 31 prevents harmonics generated in the PWM converter 33 from going back to the factory power supply 100 side.

The reactor 32 and the PWM converter 33 constitute a chopper circuit, which converts alternating current into direct current and boosts the voltage. Alternating current of a specific voltage is supplied from the factory power supply 100, and direct current of a voltage higher than the specific voltage is outputted from the PWM converter 33. The PWM converter 33 and the servo amplifier 22 are connected by a DC bus line 14. The PWM converter 33 also monitors the voltage on the DC bus line 14.

### 1-4. Power Storage System

The power storage system 6 has an initial charging circuit 41, a plurality of electric double layer capacitors 42, and a short circuit contactor 43. The initial charging circuit 41 is provided on the DC bus line 14 and is a circuit for charging the electric double layer capacitors 42. That is, since the electric double layer capacitors 42 are not charged prior to operation of the press device 1, they are charged with the power supplied from the factory power supply 100. The initial charging circuit 41 has a DC/DC converter 51 and a reactor 52. The initial charging circuit 41 throttles the current so that the current will not suddenly flow into the electric double layer capacitors 42 during charging.

The short circuit contactor 43 is provided on a bypass line 15 connected to the DC bus line 14 so as to bypass the initial charging circuit 41. That is, the bypass line 15 is connected to the DC bus line 14 on the PWM converter 33 side of the initial charging circuit 41, and is connected to the DC bus line 14 on the servo amplifier 22 side of the initial charging circuit 41. When the short circuit contactor 43 is put in an ON state, the current outputted from the PWM converter 33 is supplied to the servo amplifier 22, bypassing the initial charging circuitry 41.

A plurality of electric double layer capacitors 42 are provided, and are connected to the DC bus line 14 between the initial charging circuit 41 and the servo amplifier 22. More precisely, the electric double layer capacitors 42 are connected to the DC bus line 14 between the servo amplifier 22 and the connection between the bypass line 15 and the DC bus line 14. The electric double layer capacitors 42 are able to store power supplied from the factory power supply 100 via the initial charging circuit 41. Also, because the electric double layer capacitors 42 are connected to the DC bus line 14 on the upstream side of the servo amplifier 22, the electric double layer capacitors 42 can supply accumulated power to the servomotor 21, and can store the regenerative power generated by the servomotor 21.

### 1-5. Capacitor Cooling Unit

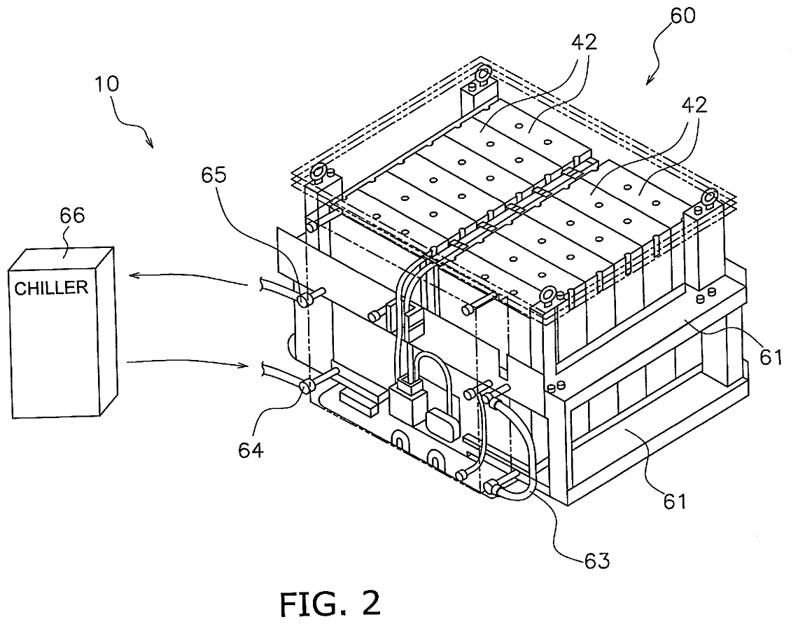

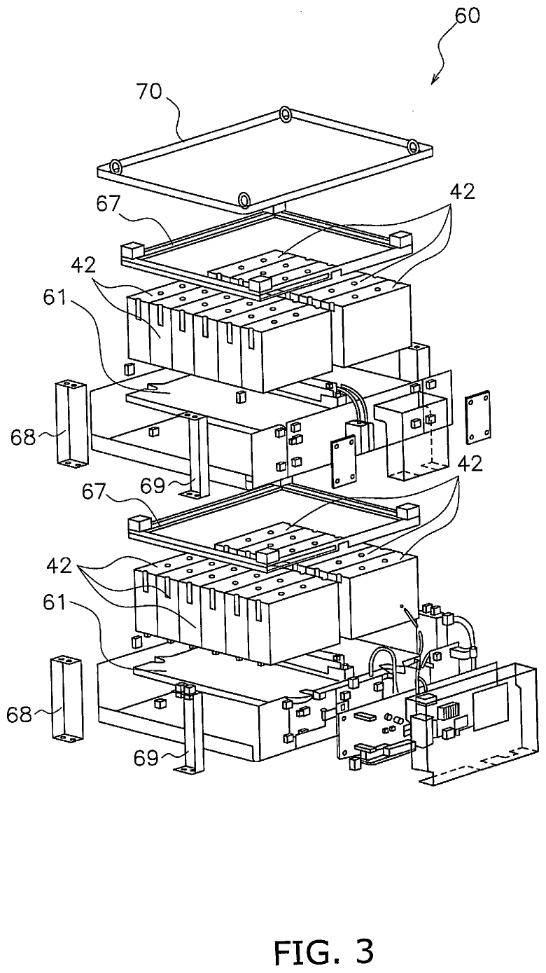

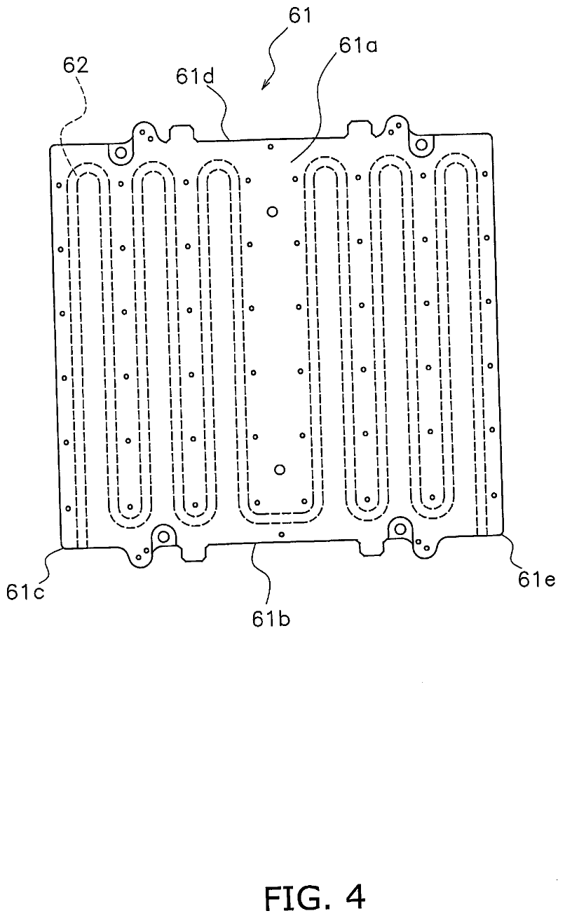

The capacitor cooling unit 10 cools the electric double layer capacitors 42. FIG. 2 shows a capacitor unit 60 provided with a plurality of the electric double layer capacitors 42. FIG. 3 is an exploded oblique view of the capacitor unit 60. As shown in FIGS. 2 and 3, the capacitor cooling unit 10 has a chiller 66 and heat sinks 61. The heat sinks 61 are plate-shaped members, and are formed from aluminum. The chiller 66 is a device for circulating cooling water, and supplies this cooling water to the heat sink 61. As shown in FIG. 4 (discussed below), a channel 62 through which cooling water flows is formed inside each heat sink 61.

In this embodiment, the capacitor unit 60 has two heat sinks 61 and twenty-four serially connected electric double layer capacitors 42. In this embodiment, 12 of the electric double layer capacitors 42 are disposed in each heat sink 61, and the two heat sinks 61 are disposed one over the other. That is, with the capacitor unit 60, a single heat sink 61 and 12 of the electric double layer capacitors 42 placed on the heat sink 61 are provided in two stages. The two heat sinks 61 and the 24 electric double layer capacitors 42 are fixed by the plurality of types of frame members 67, 68, 69, 70, etc. shown in FIG. 3.

With the press device 1 in this embodiment, four capacitor units 60 are provided and are connected in parallel to the DC bus line 14. Also, reference to the voltage of the electric double layer capacitors 42 in this Specification indicates the voltage of a capacitor unit 60 (24 electric double layer capacitors 42 connected in series).

FIG. 4 shows the configuration of the channel 62 formed in the heat sink 61. The upper-stage heat sink 61 and the lower-stage heat sink 61 have the same configuration. The heat sink 61 is substantially rectangular in plan view, and the channel 62 is formed in its interior. As shown in FIG. 4, the channel 62 snakes around the entire main face 61a of the heat sink 61. The channel 62 goes from near one corner 61c on one side 61b toward the side 61d opposite to the side 61b, then doubles back toward the side 61b near the side 61d, proceeds to the side 61b, and doubles back toward the side 61d near the side 61b. The channel 62 repeatedly doubles back near the sides 61b and 61d, ultimately reaching the vicinity of the other corner 61e of the side 61b.

The electric double layer capacitors 42 are mounted on the main face 61a on which the channel 62 is formed over the entire surface.

The upper-stage heat sink 61 and the lower-stage heat sink 61 are connected by a tube 63 as shown in FIG. 2.

Cooling water that has been cooled to a first specific temperature (20 to 30 degrees, for example) is supplied from the chiller 66 to the channel 62 of the heat sink 61. As shown in FIG. 2, the cooling water flows from the chiller 66, through an inlet 64, and into the lower-stage heat sink 61, then flows out through the channel 62 of the lower-stage heat sink 61 and into a tube 63. The cooling water then goes from the tube 63 into the upper-stage heat sink 61, goes through the channel 62 of the upper-stage heat sink 61, flows out of an outlet 65, and returns to the chiller 66.

Thus, the aluminum heat sink 61 is cooled by cooling water supplied from the chiller 66, and the electric double layer capacitors 42 disposed in contact with the heat sink 61 are cooled.

### 1-6. Storage Box

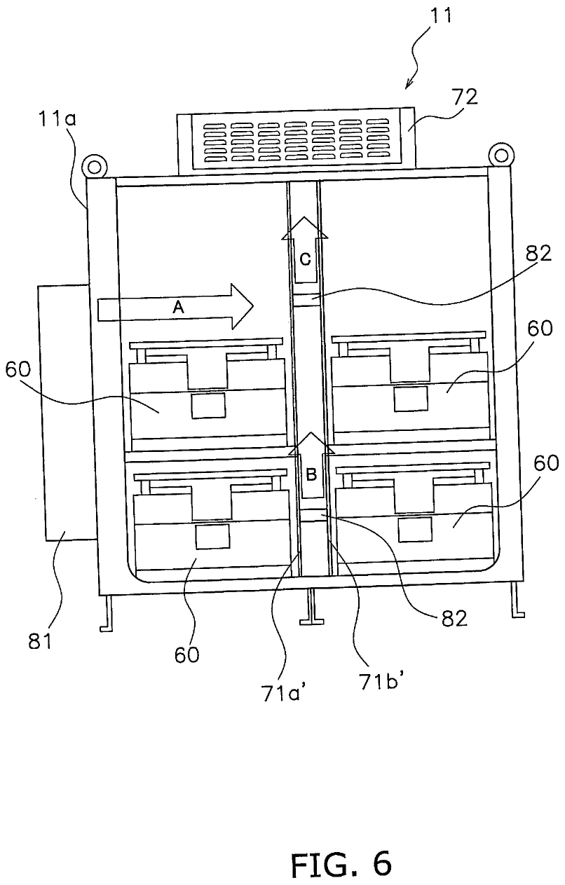

FIG. 5 is an oblique view of the storage box 11. FIG. 6 is a front view of the storage box 11. In FIGS. 5 and 6, the front doors of the storage box 11 have been removed.

As shown in FIGS. 5 and 6, four capacitor units 60 are stored in the storage box 11. The four capacitor units 60 are connected in parallel to the DC bus line 14, as mentioned above.

The storage box 11 has a box shape, and a plurality of center left frames 71a and a plurality of center right frames 71b are provided at the center in the left-right direction. The center left frames 71a and the center right frames 71b are slender members provided along the vertical direction. The center left frames 71a are disposed side by side in the front-rear direction of the storage box 11. The center right frames 71b are disposed side by side in the front-rear direction of the storage box 11. A specific gap is provided in the left-right direction between the center left frames 71a and the center right frames 71b.

Two capacitor units 60 are disposed one above the other on the left side of the center left frame 71a, and two capacitor units 60 are disposed one above the other on the right side of the center right frame 71b.

A box 72 is provided on top of the storage box 11. Resistors for forcibly discharging the electric double layer capacitors 42 are housed in the box 72.

### 1-7. Box Cooling Unit

The box cooling unit 12 cools the inside of the storage box 11 and prevents condensation by the capacitor cooling unit 10. The box cooling unit 12 has a cooler 81 and fans 82.

The cooler 81 is disposed on the left side face 11 a of the storage box 11. An air vent 11b opens on the left side face 11a, through which cooling air from the cooler 81 is supplied into the storage box 11.

Also, the two fans 82 are fixed to the innermost center left frame 71a (numbered 71a′ in FIG. 5) in the front-rear direction of the plurality of center left frames 71a, and to the innermost center right frame 71b (numbered 71b′ in FIG. 5) in the front-rear direction of the plurality of center right frames 71b. The two fans 82 are disposed at the specific gap (described above). The two fans 82 are disposed one above the other. The fans 82 are disposed such that their rotational axis runs along the vertical direction. In this embodiment, the fans 82 are provided to send air upward.

As shown by the arrow A in FIG. 6, the cooling air supplied from the cooler 81, through the air vent 11b, and into the storage box 11 is diffused as indicated the arrows B and C by the rotation of the two fans 82. This allows the cooling air to reach all parts of the storage box 11, allows temperature unevenness to be reduced.

In this embodiment, the temperature of the cooling water is set to a first specific temperature by the chiller 66, and the temperature of the cooling air supplied from the cooler 81 is set to a second specific temperature. The second specific temperature is set to a temperature that will prevent condensation by the capacitor cooling unit 10.

That is, condensation tends to occur if there is a difference between the temperature of the cooling water for cooling the electric double layer capacitors 42 and the temperature inside the storage box 11, but the temperature difference can be reduced and condensation prevented by blowing the cooling air into the interior of the storage box 11. The second specific temperature is preferably set to be no higher than the ambient temperature at an acceptable humidity when the first specific temperature is the dew point temperature.

Thus, the temperature of the cooling air supplied from the cooler 81 is set so that condensation does not occur, based on the temperature of the cooling water.

### 1-8. Controller

Once the voltage of the electric double layer capacitors 42 reaches a specific voltage due to the PWM converter 33 of the servo power supply 5, the controller 13 switches on the short circuit contactor 43 and puts the bypass line 15 in its connected state. The controller 13 outputs a signal to the servo amplifier 22 in accordance with the set motion to control the up and down operation of the slide 2.

### 2. Operation

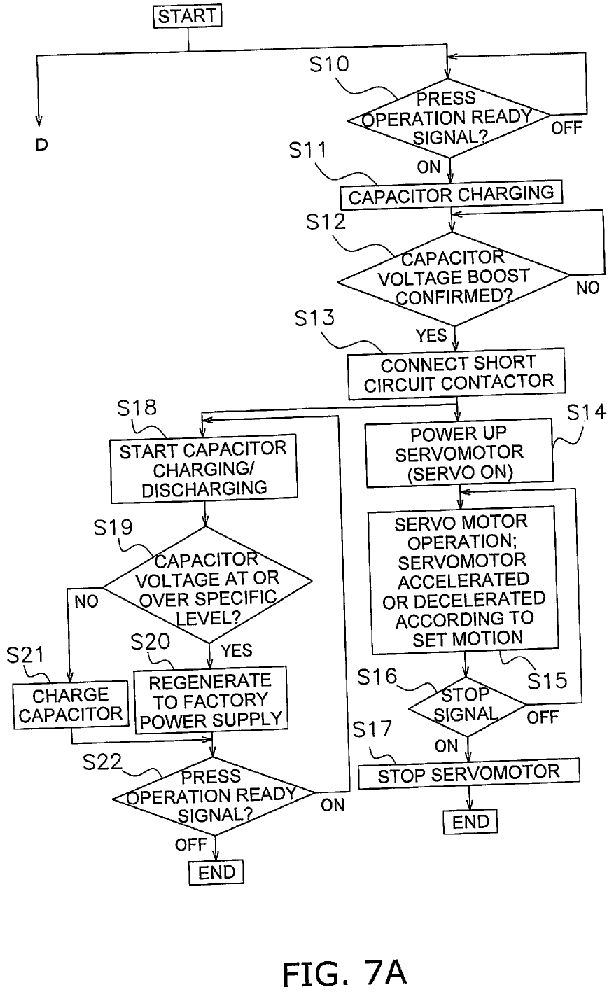

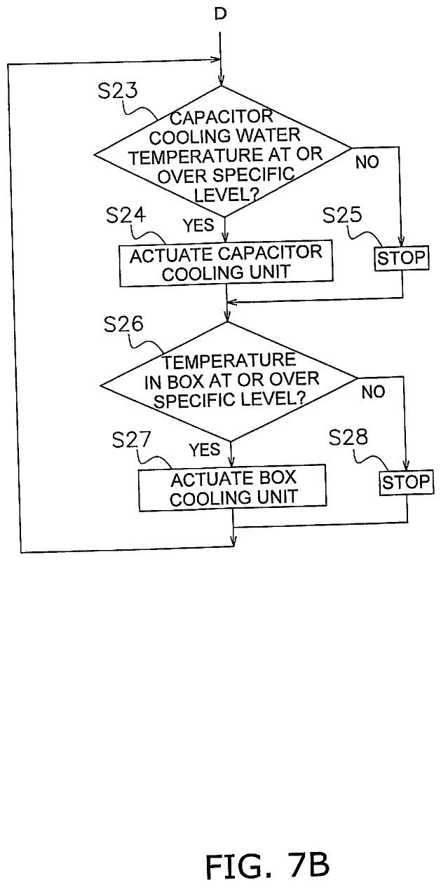

The operation of the press device 1 of the present invention will now be described. FIGS. 7A and 7B are flowcharts of the operation of the press device 1.

First, in step S10, it is determined whether or not a press operation ready signal has been outputted from the controller 13. The press operation ready signal is a signal that is outputted when the user presses a button in order to operate the press device 1, and is a signal indicating that the press device 1 is ready to operate normally.

Next, in step S11 the electric double layer capacitors 42 are charged. Since the short circuit contactor 43 is in its OFF state, no current flows to the bypass line 15, and the power outputted from the PWM converter 33 flows to the initial charging circuit 41. While current control is performed by the DC/DC converter 51 of the initial charging circuit 41, charge is stored in the electric double layer capacitors 42 connected to the DC bus line 14. The DC/DC converter 51 monitors the voltage of the DC bus line 14, and in step S12 charging is performed until the voltage of the electric double layer capacitors 42 is boosted to a specific level. The DC/DC converter 51 determines that the charging is complete and stops the operation when the input voltage and the output voltage match.

When it is detected in step S12 that the voltage of the electric double layer capacitors 42 has been boosted by the DC/DC converter 51 to the specific voltage, in step S13 the controller 13 connects the short circuit contactor 43. Consequently, the output from the PWM converter 33 is supplied to the servo amplifier 22 by bypassing the initial charging circuit 41, and in step S18 charging and discharging to and from the electric double layer capacitors 42 commences.

When the short circuit contactor 43 is connected in step S13, in step S14 the controller 13 powers up the servomotor 21.

Next, in step S15 the servomotor 21 is actuated in accordance with the set motion to move the slide 2 up and down. When the slide 2 moves downward, the servomotor 21 accelerates until it reaches a specific speed, after which it drives at a constant speed. Along with the rotation of the crankshaft 25 by the drive of the servomotor 21, the slide 2 rises after reaching bottom dead center. Then, the servomotor 21 is decelerated from a specific position in order to stop the slide 2 at top dead center.

Then, in step S16, when a servomotor 21 stop signal is outputted, the servomotor 21 is stopped in step S17. This stops the slide 2 at top dead center.

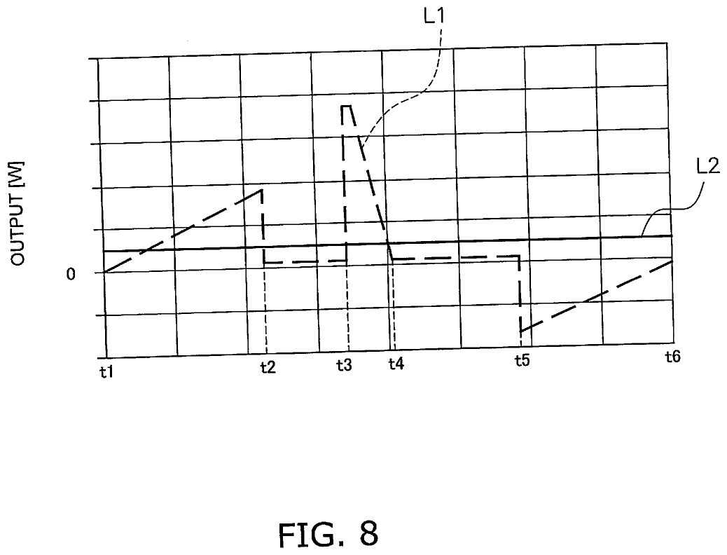

The change in power consumption during pressing will be described with reference to FIG. 8. FIG. 8 s a graph of the change in power during pressing. FIG. 8 shows a broken line L1 and solid line L2. The broken line L1 indicates the time change in the power consumption of the press device 1 during pressing. The solid line L2 indicates the time change in the power supplied from the factory power supply 100.

The downward movement of the slide 2 begins at the time t1 in FIG. 8, and between the times t1 and t2, the servomotor 21 is accelerated until it reaches a specific speed, and power is consumed by the servomotor 21. When power is consumed by the servomotor 21 and the voltage of the DC bus line 14 decreases, the servo power supply 5 supplies a preset constant power. As shown by the solid line L2, only a constant power is supplied from the servo power supply 5, so any extra power that is needed is supplied from the electric double layer capacitors 42. That is, the portion of the broken line L1 that goes beyond the solid line L2 is supplied from the electric double layer capacitors 42.

When the speed of the servomotor 21 reaches a specific speed at the time t2, the servomotor 21 is driven at a constant speed starting at the time t2. Since the load on the servomotor 21 is light from the time t2 to the time t3 when the upper die is in contact with the workpiece, the power consumption indicated by the broken line L1 is low. At this point, the electric double layer capacitors 42 are charged with the portion of power where the solid line L2 goes beyond the broken line L1.

Next, the slide 2 descends further from the time t3, and pressing is performed on the workpiece until the time t4. At this point power consumption peaks, but as described above, the servo power supply 5 supplies a preset constant power, and any extra power that is needed is supplied from the electric double layer capacitors 42.

When the slide 2 reaches a specific position, the controller 13 decelerates the servomotor 21 to stop the slide 2 at top dead center. In FIG. 8, the time t5 indicates the deceleration start time of the servomotor 21, the time t6 indicates the deceleration end. As shown in FIG. 8, from the time t5 to the time t6 the output is on the negative side, and regenerative power is generated in the servomotor 21. This regenerative power is used to charge the electric double layer capacitors 42.

Meanwhile, during the pressing in steps S14 to S17, the control of steps S18 to S22 is carried out in parallel. As described above, when the short circuit contactor 43 is connected in step S13, charging and discharging of the electric double layer capacitors 42 is commenced in step S18.

Then, in the next step S19, the PWM converter 33 determines whether or not the voltage of the DC bus line 14 is equal to or greater than a specific voltage. When the voltage of the DC bus line 14 is at least the specific voltage, the control proceeds to step S20, and power is regenerated to the factory power supply 100 by the power regeneration function of the PWM converter 33. Since the voltage of the DC bus line 14 is equal to the voltage of the electric double layer capacitors 42, the PWM converter 33 senses the voltage of the electric double layer capacitors 42. That is, when the charge of the electric double layer capacitors 42 becomes equal to or more than a specific amount, the regenerative power generated by the servomotor 21 is regenerated to the factory power supply 100. In step S19, when the voltage of the DC bus line 14 is less than the specific voltage, the electric double layer capacitors 42 are charged in step S21.

In the next step S22, it is detected whether or not a press operation ready signal has been outputted from the controller 13. Steps S18 to S21 are repeated while the press operation ready signal is being detected. In step S22, when it is detected that no press operation ready signal has been outputted from the controller 13, control ends.

After the electric double layer capacitors 42 have been charged the first time, charging of the electric double layer capacitors 42 is carried out by regenerative power produced during deceleration of the servomotor 21, etc. Therefore, input from the factory power supply 100 need not be performed.

As described above, because electric double layer capacitors 42 that can be charged are provided, any shortage in power will be supplied from the electric double layer capacitors 42, so the power supplied from the factory supply 100 can be kept constant as shown in FIG. 8.

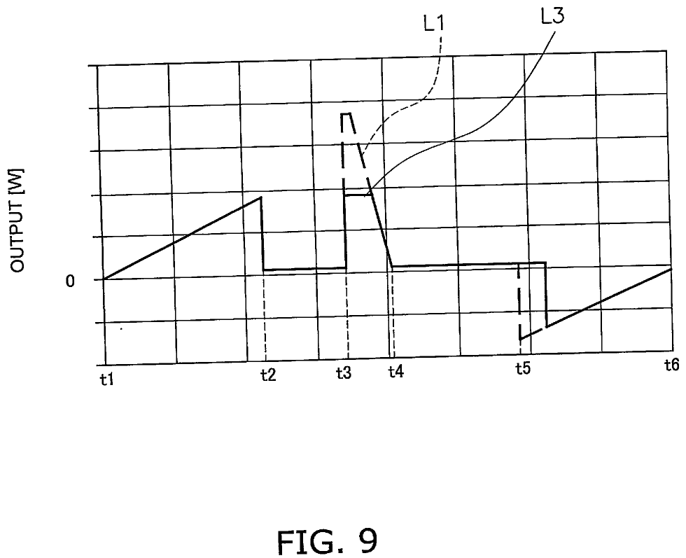

FIG. 9 shows the power supplied from the factory power supply 100 when aluminum electrolytic capacitors of the same installation volume are used instead of the electric double layer capacitors 42. In FIG. 9, the power supplied from the factory supply 100 is indicated by a solid line L3, and the broken L1 is the same as in FIG. 8. Aluminum electrolytic capacitors have a lower volume than the electric double layer capacitors 42, so only part of the peak power is supplied as shown in the comparative example of FIG. 9, and the effect of reducing the voltage drop is diminished. Further, as shown in FIG. 9, the power supplied from the factory power supply 100 (the solid line L3) cannot be kept constant, and the power consumption is also higher.

Also, in parallel with the control of steps S10 to S22, the capacitor cooling unit 10 and the box cooling unit 12 are controlled in steps S23 to S28 shown in FIG. 7B.

In step S23, when the cooling water of the electric double layer capacitors 42 is found to be at or over the first specific temperature, the capacitor cooling unit 10 is actuated in step S24, and the cooling water that is being circulated by the chiller 66 is cooled. On the other hand, in step S23, when the cooling water of the electric double layer capacitors 42 is found to be below the first specific temperature, the capacitor cooling unit 10 comes to a halt, and the circulating cooling water is not cooled. This controls the temperature of the circulating coolant to the first specific temperature.

Also, after steps S24 S25, when it is found in step S26 that the temperature in the storage box 11 is at or over the second specific temperature, the box cooling unit 12 is actuated in step S27, and cooling air is supplied by the cooler 81 into the storage box 11. On the other hand, if when is found in step S26 that the temperature in the storage box 11 is below the second specific temperature, the box cooling unit 12 comes to a halt, and the supply of cooling air from the cooler 81 is stopped. The fans 82 may be driven at all times. This controls the temperature in the storage box 11 to the second specific temperature. 3. Features, etc.

### (3-1)

The press device 1 according to this embodiment is a press device to subject a material to pressing by using the upper die 7 and the lower die 8, and comprises the slide 2, the bolster 3, the servomotor 21, the electric double layer capacitors 42, and the capacitor cooling unit 10 (an example of a cooling unit). The upper die 7 is attached to the lower face of the slide 2. The bolster 3 is disposed below the slide 2, and the lower die 8 is placed on the bolster 3. The servomotor 21 drives the slide 2. The electric double layer capacitors 42 can supply stored power to the servomotor 21. The capacitor cooling unit 10 cools the electric double layer capacitors 42.

As described above, using the large-capacity electric double layer capacitors 42 for storing electricity makes it possible to supply power from the electric double layer capacitors 42 and perform sufficient power assist when power consumption peaks. This minimizes the decrease in voltage.

Also, since electric double layer capacitors 42 have a large capacity, the power supplied from the factory power supply 100 can be kept constant, so the power supply capacity can be reduced.

In addition, since the electric double layer capacitors 42 have a higher internal resistance than aluminum electrolytic capacitors, they are prone to generating heat when used in the press device 1 through which a large current flows instantaneously, but providing the capacitor cooling unit 10 as described above eliminates this generated heat, allowing the electric double layer capacitors 42 to be used in the press device 1.

### (3-2)

With the press device 1 according to this embodiment, the electric double layer capacitors 42 are able to store the power supplied from the factory power supply 100 (an example of externally supplied power).

Consequently, storing power in the electric double layer capacitors 42 in advance allows power to be supplied from the electric double layer capacitors 42 when the consumption of power peaks.

### (3-3)

With the press device 1 according to this embodiment, the electric double layer capacitors 42 can store the regenerative power of the servomotor 21.

Since the electric double layer capacitors 42 have a large capacity, the regenerative power generated during deceleration of the servomotor 21 can be sufficiently stored, and the stored power can be supplied during power running of the servomotor 21, so power consumption can be reduced.

### (3-4)

With the press device 1 according to this embodiment, the capacitor cooling unit 10 (an example of a cooling unit) uses cooling water (an example of a liquid) to cool the electric double layer capacitors 42.

Consequently, the electric double layer capacitors can be efficiently cooled using water as the liquid, for example.

### (3-5)

The press device 1 according to this embodiment further comprises the heat sinks 61. The heat sinks 61 are disposed in contact with the electric double layer capacitors 42. The channel 62 through which the cooling water (an example of a liquid) flows is formed in the heat sinks 61.

This allows the electric double layer capacitors 42 to be cooled by the liquid flowing through the channel 62, via the heat sinks 61.

### (3-6)

The press device 1 according to this Embodiment comprises the cooler 81 (an example of a cooling air supply unit). The cooler 81 supplies cooling air to the capacitor unit 60, which has a plurality of the electric double layer capacitors 42 and heat sinks 61 that are in contact with the electric double layer capacitors 42.

Blowing cooling air from the outside to the capacitor unit 60 allows the temperature around the capacitor unit 60 to be lowered. This suppresses the temperature difference between the ambient temperature and the heat sinks 61, and prevents condensation.

### (3-7)

The press device 1 according to this embodiment comprises a storage box 11 and fans 82. The storage box 11 holds a plurality of capacitor units 60, and cooling air is blown in from a cooler 81 (an example of a cooling air supply unit). The fans 82 are provided in the storage box 11 and diffuse the cooling air supplied from the cooler 81.

Thus providing the fans 82 allows the cooling air to be diffused in the storage box 11, and the occurrence of temperature unevenness can be reduced.

### 4. Other Embodiments

An embodiment of the present invention was described above, but the present invention is not limited to or by the above embodiment, and various modifications are possible without departing from the gist of the invention.

### (A)

In the above embodiment, the capacitor cooling unit 10 cools the electric double layer capacitors 42 with cooling water, but a coolant or the like may be used instead. Furthermore, oil may be used as the liquid flowing through the channel 62. With oil cooling, the oil need not flow through the channel 62 as in the above embodiment, and cooling may be accomplished by immersing the electric double layer capacitors 42 in oil.

### (B)

In the above embodiment, the capacitor cooling unit 10 cools the electric double layer capacitors 42 with a liquid, but may use air cooling instead.

### (C)

In the above embodiment, four capacitor units 60 in each of which 24 electric double layer capacitors 42 are connected in series are provided, and the four capacitor units 60 are connected in parallel, but the number of units and how they are connected are not limited to this configuration.

### (D)

In the above embodiment, the four capacitor units 60 are disposed in the storage box 11, and the cooler 81 blows cooling air into the storage box 11, but this is not the only disposition configuration that is possible. The four capacitor units 60 may be disposed side by side or vertically.

Also, the number and position of the fans 82 are not limited to the configuration in the above embodiment.

The important thing is that the difference between the ambient temperature of the capacitor units 60 and the cooling temperature of the capacitor cooling unit 10 can be kept small, and condensation can be minimized.

### (E)

In the above embodiment, the box cooling unit 12 is provided for cooling the storage box 11, but if the capacitor units 60 are disposed under conditions such that condensation will not be caused by the heat sinks 61 of the capacitor cooling unit 10, the box cooling unit 12 may not be provided.

The press device of the present invention can suppress a voltage drop, and is useful, for example, in a servo press device that requires a large current instantaneously.

1. A press device configured to subject a material to pressing by using an upper die and a lower die, the press device comprising:
a slide, the upper die being attached to a lower face of the slide;
a bolster disposed below the slide, the lower die being disposed on the bolster;
a servomotor configured to drive the slide;
an electric double layer capacitor capable of supplying stored electric power to the servomotor; and
a cooling unit configured to cool the electric double layer capacitor.

2. The press device according to claim 1, wherein
the electric double layer capacitor is capable of storing externally supplied power.

3. The press device according to claim 1, wherein
the electric double layer capacitor is capable of storing regenerative electric power of the servomotor.

4. The press device according to claim 1, wherein
the cooling unit uses a liquid to cool the electric double layer capacitor.

5. The press device according to claim 4, further comprising:
a heat sink disposed in contact with the electric double layer capacitor,
a channel through which the liquid flows being formed in the heat sink.

6. The press device according to claim 5, further comprising:
a cooling air supply unit configured to supply cooling air to a capacitor unit including
a plurality of the electric double layer capacitors and
the heat sink disposed in contact with the plurality of electric double layer capacitors.

7. The press device according to claim 6, further comprising:
a storage box storing a plurality of the capacitor units, cooling air being fed from the cooling air supply unit to the storage box; and
a fan provided in the storage box, the fan being configured to diffuse the cooling air supplied from the cooling air supply unit.

8. The press device according to claim 1, wherein
the cooling unit uses a liquid to cool the electric double layer capacitor, and
the cooling unit includes
a heat sink disposed in contact with the electric double layer capacitor, a channel through which the liquid flows being formed in the heat sink, and
a chiller configured to supply the liquid to the channel in the heat sink.

9. The press device according to claim 8, further comprising
a cooling air supply unit configured to supply cooling air to a capacitor unit,
the capacitor unit including
a plurality of the electric double layer capacitors and
the heat sink disposed in contact with the plurality of electric double layer capacitors.

10. The press device according to claim 9, further comprising
a storage box storing a plurality of the capacitor units, cooling air being fed from the cooling air supply unit to the storage box,
the chiller being disposed outside the storage box.

11. The press device according to claim 9, wherein
a temperature of the liquid is set to a first specific temperature,
a temperature of the cooling air is set to a second specific temperature, and
the second specific temperature is set to be no higher than an ambient temperature at an acceptable humidity when the first specific temperature is a dew point temperature.
